(19) United States
(12) Patent Application Publication
(10) Pub. No.: US 2026/0322647 A1
(43) Pub. Date: Oct. 15, 2026

(54) COMMUNICATION METHOD, FIRST COMMUNICATION DEVICE, AND REMOTE DIAGNOSTIC SYSTEM

(71) Applicant: Autel Intelligent Technology Corp., Ltd., Shenzhen (CN)

(72) Inventor: Zhipeng DU, Shenzhen (CN)

(73) Assignee: Autel Intelligent Technology Corp., Ltd., Shenzhen (CN)

(21) Appl. No.: 19/690,368

(22) Filed: May 28, 2026

Related U.S. Application Data
(63) Continuation of application No. PCT/CN2024/134029, filed on Nov. 23, 2024.

(30) Foreign Application Priority Data
Nov. 28, 2023 (CN) 202311626492.0

(51) Int. Cl. H04L 12/40; H04L 61/5038; H04L 67/12; H04L 69/24

(52) U.S. Cl. CPC H04L 12/40032; H04L 61/5038; H04L 67/12; H04L 69/24; H04L 2012/40273; H04L 2212/00

(57) ABSTRACT

Provided are a communication method, a first communication device, and a remote diagnostic system. The communication method is applied in a first communication device and includes: obtaining a first message of a vehicle or a diagnosis device, the first message being a message of a physical link layer of a Diagnostic Communication over Internet Protocol (DoIP); performing encapsulation on the first message according to a protocol of a second local area network or a first wide area network, and obtaining an encapsulated first message; and sending the first message to a second communication device. In this method, the first message sent by the vehicle or the diagnosis device is not decapsulated layer-by-layer in the first communication device, but rather is directly sent to the second communication device after being encapsulated by the first communication device, which can reduce the time the first communication device processes the first message.

### CROSS-REFERENCE TO RELATED APPLICATIONS

This application is a continuation of PCT Patent Application No. PCT/CN2024/134029, filed on Nov. 23, 2024, which claims priority to Chinese Patent Application No. 202311626492.0, filed on Nov. 28, 2023. The entire disclosures of each of the aforementioned applications are incorporated herein by reference in their entirety and for all purposes.

### TECHNICAL FIELD

The present disclosure relates to the technical field of vehicle diagnosis, and in particular, to a communication method, a communication apparatus, and a remote diagnostic system.

### BACKGROUND

For remote diagnosis, by establishing a communicative connection between a first communication device communicatively connected to a vehicle and a second communication device communicatively connected to a diagnosis device of a maintenance manufacturer, the first communication device may forward a message to the vehicle or the second communication device, and the second communication device may forward a message to the diagnosis device or the first communication device, so as to achieve remote diagnosis.

However, in a current communication method of a remote terminal system, after obtaining a message sent by the vehicle or a server, the first communication device or the second communication device needs to firstly decapsulate the message layer-by-layer according to an order of a data link layer, a network layer, a transport layer and an application layer to obtain a message of the application layer, and then send the message to the vehicle or the server, or send the message to the diagnosis device or the server after encapsulating the message of the application layer layer-by-layer according to an order of the application layer, the transport layer, the network layer and the data link layer. In this communication method, the first communication device and the second communication device need to decapsulate and encapsulate the message layer-by-layer, which results in a long time consumed for message processing and a relatively low communication speed in a remote diagnostic system.

### SUMMARY

Embodiments of the present disclosure provide a communication method, a communication device, and a remote diagnostic system, which can reduce the time consumed for message processing and improve communication speed in the remote diagnostic system.

In a first aspect, the present disclosure provides a communication method, being applied to a first communication device, where the first communication device is configured for being communicatively connected to a vehicle or a diagnosis device, the vehicle and the diagnosis device being disposed in a first local area network, the first communication device and a second communication device being disposed in a second local area network or a first wide area network; and the method including: acquiring a first message of the vehicle or the diagnosis device, the first message being a message of a physical link layer of a Diagnostic Communication over Internet Protocol (DoIP); performing encapsulation on the first message according to a protocol of the second local area network or the first wide area network, and obtaining an encapsulated first message; and sending the encapsulated first message to the second communication device.

In this embodiment, since the vehicle and the diagnosis device are disposed in the first local area network, and the first communication device and the second communication device are disposed in the second local area network or the first wide area network, the first message sent by the vehicle or the diagnosis device is not decapsulated layer-by-layer in the first communication device, but rather is directly sent to the second communication device after being encapsulated by the first communication device according to the protocol of the second local area network or the first wide area network. Compared with a processing mode in which the first communication device decapsulates the received first message layer-by-layer and then encapsulates the first message layer-by-layer, the present embodiment can reduce the amount of time the first communication device processes the first message and improve communication speed.

In a second aspect, the present disclosure provides a first communication device, including: one or more processors; and a memory communicatively connected to the one or more processors; where the memory stores instructions executable by the one or more processors, and the instructions are executed by the one or more processors to cause the one or more processors to execute the method according to the first aspect.

In a third aspect, the present disclosure provides a remote diagnostic system, including the first communication device according to the second aspect, a second communication device, a diagnosis device, and a vehicle; where the first communication device is communicatively connected to the vehicle and the second communication device, and the second communication device is further communicatively connected to the diagnosis device; or the first communication device is communicatively connected to the diagnosis device and the second communication device, and the second communication device is further communicatively connected to the vehicle.

In the remote diagnostic system, the first communication device or the second communication device directly encapsulates the message sent by the vehicle or the diagnosis device and then sends the message to an opposite end, which reduces the time consumed for message processing by the first communication device or the second communication device and improves communication speed in the remote diagnostic system.

In the remote diagnostic system, through the above disposition, the first communication device and the second communication device can perform encapsulation and decapsulation on the message according to the corresponding protocol, which reduces the time consumed for message processing and improves communication speed.

In the remote diagnostic system, the first communication device can be communicatively connected to the second communication device through the server, which ensures the communication quality.

In a fourth aspect, the present disclosure further provides a non-transitory computer-readable storage medium, storing computer-executable instructions, where the computer-executable instructions are used for causing a computer to execute the method according to any one of the embodiments in the first aspect.

In a fifth aspect, the present disclosure further provides a computer program product, including a computer program stored on a computer-readable storage medium, where the computer program includes program instructions, and the program instructions, when executed by a computer, cause the computer to execute the method according to any one of the embodiments in the first aspect.

Embodiments of the present disclosure provide a communication method, a first communication device, and a remote diagnostic system. The communication method is applied to a first communication device, the first communication device is used for being communicatively connected to a vehicle or a diagnosis device, the vehicle and the diagnosis device are disposed in a first local area network, and the first communication device and a second communication device are disposed in a second local area network or a first wide area network. The method includes: obtaining a first message of the vehicle or the diagnosis device, the first message being a message of a physical link layer of a Diagnostic Communication over Internet Protocol (DoIP); performing encapsulation on the first message according to a protocol of the second local area network or the first wide area network, and obtaining an encapsulated first message; and sending the first message to the second communication device. In the present embodiment, since the vehicle and the diagnosis device are disposed in the first local area network, and the first communication device and the second communication device are disposed in the second local area network or the first wide area network, the first message sent by the vehicle or the diagnosis device is not decapsulated layer-by-layer in the first communication device, but rather is directly sent to the second communication device after being encapsulated by the first communication device according to the protocol of the second local area network or the first wide area network, which can reduce the amount of time the first communication device processes the first message and improve communication speed.

### BRIEF DESCRIPTION OF DRAWINGS

One or more embodiments are exemplarily illustrated by the figures in the corresponding accompanying drawings, and these exemplary illustrations do not constitute limitations on the embodiments. Elements/modules and steps with the same reference numerals in the accompanying drawings are represented as similar elements/modules and steps. Unless otherwise specified, the figures in the accompanying drawings do not constitute a scale limitation.

FIG. 1 is a schematic structural diagram of a remote diagnostic system according to an embodiment of the present disclosure;

FIG. 2 is a schematic structural diagram of another remote diagnostic system according to an embodiment of the present disclosure;

FIG. 3 is a schematic diagram of a communication structure of a remote diagnostic system according to the prior art;

FIG. 4 is a schematic diagram of a communication structure of a remote diagnostic system according to an embodiment of the present disclosure;

FIG. 5 is a schematic flow diagram of a communication method according to an embodiment of the present disclosure;

FIG. 6 is a schematic partial flow diagram of the communication method according to an embodiment of the present disclosure;

FIG. 7 is a schematic flow diagram of step S120 in FIG. 5 according to an embodiment of the present disclosure;

FIG. 8 is another schematic flow diagram of step S120 in FIG. 5 according to an embodiment of the present disclosure; and

FIG. 9 is a structural block diagram of a communication device according to an embodiment of the present disclosure.

### DETAILED DESCRIPTION

The present disclosure will be described in detail below with reference to specific embodiments. The following embodiments will help those skilled in the art further understand the present disclosure, but do not limit the present disclosure in any form. It should be noted that several modifications and improvements can also be made by those ordinarily skilled in the art without departing from the concept of the present disclosure, and these modifications and improvements all fall within the protection scope of the present disclosure.

For the convenience of understanding the present disclosure, the present disclosure will be described in more detail below with reference to the accompanying drawings and specific embodiments. Unless otherwise defined, all technical and scientific terms used in this specification have the same meanings as those commonly understood by those skilled in the technical field to which the present disclosure belongs. The terms used in the specification of the present disclosure are only for the purpose of describing specific embodiments, and are not used for limiting the present disclosure. The term “and/or” used in this specification includes any and all combinations of one or more of the listed related items.

It should be noted that various features in the embodiments of the present disclosure can be combined with each other without conflict, all of which fall within the protection scope of the present disclosure. In addition, although functional modules are divided in the schematic diagram of the apparatus, under some conditions, the modules can be divided differently from those in the apparatus. In addition, the terms “first”, “second” and the like adopted herein do not limit the data and execution order, but only distinguish the same or similar items with basically the same functions and effects.

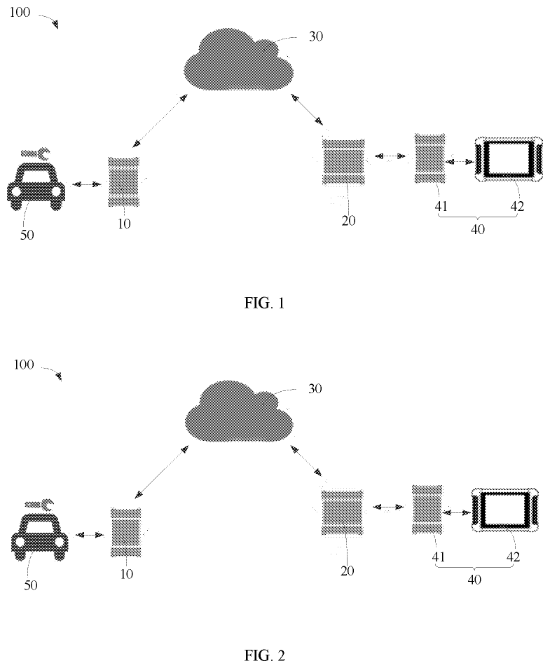

FIG. 1 is a schematic structural diagram of a remote diagnostic system 100 according to an embodiment of the present disclosure. The remote diagnostic system 100 includes a first communication device 10, a second communication device 20, and a server 30, where the first communication device 10 is communicatively connected to a vehicle 50 and the server 30, and the second communication device 20 is communicatively connected to the server 30 and a diagnosis device 40.

In an embodiment, the first communication device 10 is a vehicle communication interface (VCI) which is an electronic device having computing and processing capabilities and integrated with a communication interface, such as an on-board diagnostics (OBD) interface. The first communication device 10 can be communicatively connected to an OBD interface of the vehicle 50 through the OBD interface, and the first communication device 10 can convert data on a vehicle bus into data recognizable by the server 30, and can also convert data issued by the server 30 into data recognizable by the vehicle bus. In addition, the first communication device 10 also has a wireless communication function, can be communicatively connected to the server 30 through a network such as WIFI, and can also be communicatively connected to the server 30 in a wired connection mode, thereby enabling communication to be more reliable. In some embodiments, the first communication device 10 further includes a touch display screen, so as to receive operation of an operator or display operation instructions, diagnosis conditions or related data, and the like.

Referring to FIG. 2, in some embodiments, the first communication device 10 includes a first communication apparatus 11 and a first mobile terminal 12 which are independent of each other. Herein, the first communication apparatus 11 can be a VCI, and the first mobile terminal 12 can be a tablet computer, a smart phone or handheld smart devices in various forms. In the present embodiment, the first communication apparatus 11 is wiredly connected to the OBD interface of the vehicle 50 and also wiredly connected to the first mobile terminal 12, for example, can be wiredly connected to the first mobile terminal 12 by adopting a universal serial bus (USB). The first mobile terminal 12 is communicatively connected to the server 30 through a network such as WIFI, and the first mobile terminal 12 can also be communicatively connected to the server 30 in a wired connection mode, thereby enabling communication to be more reliable. It can be understood that the first mobile terminal 12 includes a touch display screen, so as to receive operation of an operator or display operation instructions, diagnosis conditions or related data, and the like.

The second communication device 20 is a VCI which is an electronic device having computing and processing capabilities and integrated with a communication interface, such as an OBD interface. The second communication device 20 can be communicatively connected to an OBD interface of the diagnosis device 40 through the OBD interface, and the second communication device 20 can convert data on a diagnosis device bus into data recognizable by the server 30, and can also convert data issued by the server 30 into data recognizable by the diagnosis device 40 bus. In addition, the second communication device 20 can have a wireless communication function, can be communicatively connected to the server 30 through a network such as WIFI, and can also be communicatively connected to the server 30 in a wired connection mode, thereby enabling communication to be more reliable. In some embodiments, the second communication device 20 further includes a touch display screen, so as to receive operation of an operator or display operation instructions, diagnosis conditions or related data, and the like.

Referring to FIG. 2 again, in some embodiments, the second communication device 20 includes a second communication apparatus 21 and a second mobile terminal 22 which are independent of each other. Herein, the second communication apparatus 21 can be a VCI, and the second mobile terminal 22 can be a tablet computer, a smart phone or handheld smart devices in various forms, where the second communication apparatus 21 is communicatively connected to the second mobile terminal 22 through an Internet of Things (IoT) server 31, and the IoT server 31 is specially responsible for transmitting commands for synchronizing human-machine interaction states.

In the present embodiment, the second communication apparatus 21 is wiredly connected to the OBD interface of the diagnosis device 40 and also connected to the second mobile terminal 22 through a server network. The second mobile terminal 22 is communicatively connected to the server 30 through a network, such as a network cable or WIFI. It can be understood that the second mobile terminal 22 includes a touch display screen, so as to receive operation of an operator or display operation instructions, diagnosis conditions or related data, and the like.

That is, the first communication device 10 and the second communication device 20 can be the same communication device with the same hardware and software. The only difference is that the first communication device 10 is applied to a vehicle-proximal end and communicatively connected to the OBD interface of the vehicle 50 and the server 30, and the second communication device 20 is applied to a vehicle-remote end and used for being communicatively connected to the diagnosis device 40 and the server 30. It can be understood by those skilled in the art that “first” and “second” herein do not constitute any limitation on the communication devices.

The server 30 can be a local physical server or a cloud device, such as a cloud server, a cloud host, a cloud service platform, and a cloud computing platform. The cloud device is communicatively connected to the first communication device 10 or the second communication device 20 through a network, and the two are communicatively connected through a predetermined communication protocol. Specifically, the communication protocol can be protocols such as a transmission control protocol/internet protocol (TCP/IP). In other embodiments, the first communication device 10 can be communicatively connected to the second communication device 20 by adopting a Peer-to-Peer (P2P) protocol, so that the first communication device 10 can be communicatively connected to the second communication device 20 without the server 30, that is, the server 30 may not be included in the remote diagnostic system 100.

The diagnosis device 40 is a portable intelligent vehicle fault self-check instrument for detecting vehicle faults. A user can utilize the diagnosis device 40 for quickly reading faults in a vehicle electronic control system, fault information is displayed through a liquid crystal display screen, and the location and cause of the fault can be quickly found out. It can be understood that an existing vehicle diagnosis instrument on the market can be adopted as the diagnosis device 40, which includes an upper computer 42 and a lower computer 41, and the two can be connected in a wired or wireless connection manner, for example, connected through a USB, Bluetooth, and WIFI. The upper computer 42 can be a device such as a tablet and a computer for human-computer interaction, and the lower computer 41 can be a VCI for being communicatively connected to the upper computer 42 and the second communication device 21. The structure and working principle of the diagnosis device 40 are well known to those skilled in the art, and will not be described in detail herein.

In some embodiments, both the first communication device 10 (for example, the first mobile terminal therein) and the second communication device 20 (for example, the second mobile terminal therein) are loaded with application software. It can be understood that the application software serves as a platform for remote communication, and a requester at the vehicle-proximal end can post a help-seeking question on the application software in the first communication device 10 or the first mobile terminal and upload the help-seeking question to the server 30. Related technical experts can obtain the help-seeking question on the application software in the second communication device 20 or the second mobile terminal, so as to help the requester solve the help-seeking question.

In the above mode, a communication network from the vehicle to the first communication device 10, the server 30, the second communication device 20 and the diagnosis device 40 is formed. In the communication network, any two entities can communicate with each other, so that the diagnosis device 40 is not limited by a geographic position, that is, it is not necessary to confine the diagnosis device 40 to the vicinity of the vehicle, thereby achieving remote diagnosis and providing a wider range of fault solution channels for the vehicle. For example, when maintenance personnel of a vehicle maintenance shop cannot solve the fault, the maintenance personnel can seek help remotely, find more experienced technical experts, and enable the vehicle 50 to be communicatively connected to the diagnosis device 40 through the above communication network to solve the fault. For another example, when the diagnosis device of the vehicle maintenance shop does not match with the model of a faulty vehicle, the faulty vehicle can be communicatively connected to a matched diagnosis device 30 remotely to solve the fault. It can be seen that remote diagnosis can integrate expert resources and diagnosis device resources, thereby improving the maintenance efficiency.

The above is only an illustrative description of the remote diagnostic system 100, and the remote diagnostic system 100 can also be achieved in other hardware plus software modes. For example, the function of the second communication device 20 can be achieved by software, a network communication interface can be added to the software of the diagnosis device 40, and data transmission with the server 30 is performed through the network communication interface.

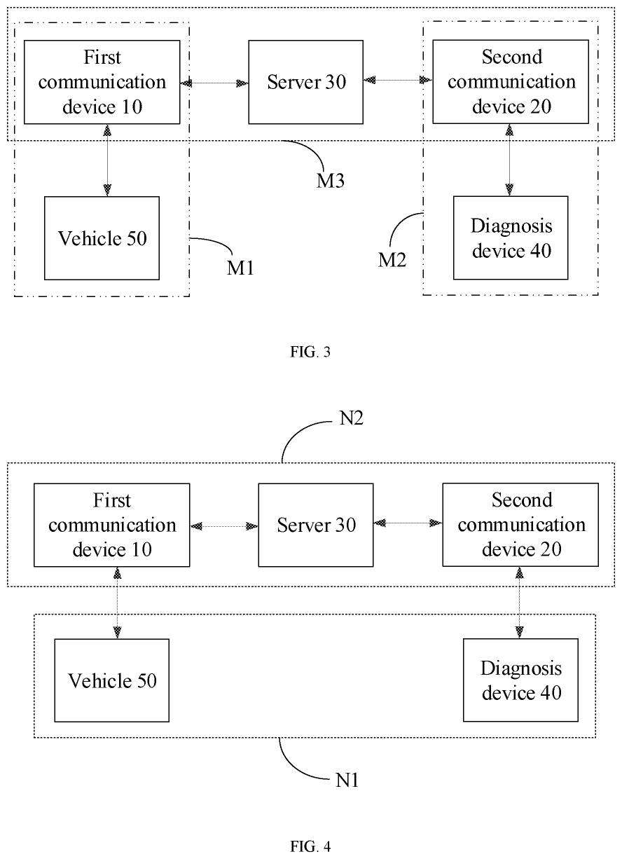

Referring to FIG. 3, in the remote diagnostic system, the first communication device 10 and the vehicle 50 are generally disposed in a third local area network M1, the first communication device 10, the server 30 and the second communication device 20 are disposed in a second wide area network M3, and the second communication device 20 and the diagnosis device 40 are disposed in a fourth local area network M2. If the server 30 is omitted, the first communication device and the second communication device 20 are disposed in a fifth local area network. Then, during communication, the first communication device 10 and the second communication device 20 need to perform decapsulation and encapsulation on a message layer-by-layer to forward the message. Taking the embodiment shown in FIG. 3 as an example, after acquiring a message sent by the vehicle 50 or the server 30, the first communication device 10 needs to firstly decapsulate the message layer-by-layer according to an order of a physical link layer, a data link layer, a network layer and a transport layer of the third local area network M1 or the second wide area network M3 to acquire a message of an application layer, and then send the message to the server 30 or the vehicle 50 after encapsulating the message of the application layer layer-by-layer according to an order of the transport layer, the network layer, the data link layer and the physical link layer of the second wide area network M3 or the fourth local area network M2. Similarly, after acquiring a message sent by the diagnosis device 40 or the server 30, the second communication device 20 needs to firstly decapsulate the message layer-by-layer according to an order of a physical link layer, a data link layer, a network layer and a transport layer of the fourth local area network M2 or the second wide area network M3 to acquire a message of an application layer, and then send the message to the server 30 or the diagnosis device 40 after encapsulating the message of the application layer layer-by-layer according to an order of the transport layer, the network layer, the data link layer and the physical link layer of the second wide area network M3 or the fourth local area network M2. It can be seen that in this communication mode, and in this communication method, the first communication device 10 and the second communication device 20 need to perform decapsulation and encapsulation on the message layer-by-layer, which results in a long time consumed for message processing and a relatively low communication speed in a remote diagnostic system, thereby being not conducive to remote diagnosis.

Based on this, the present disclosure provides a communication method, a communication device, and a remote diagnostic system, which directly encapsulate a message sent by the vehicle 50 or the diagnosis device 40 and then send the message to an opposite end, which can reduce the time consumed for message processing by the first communication device 10 or the second communication device 20 and improve communication speed in the remote diagnostic system.

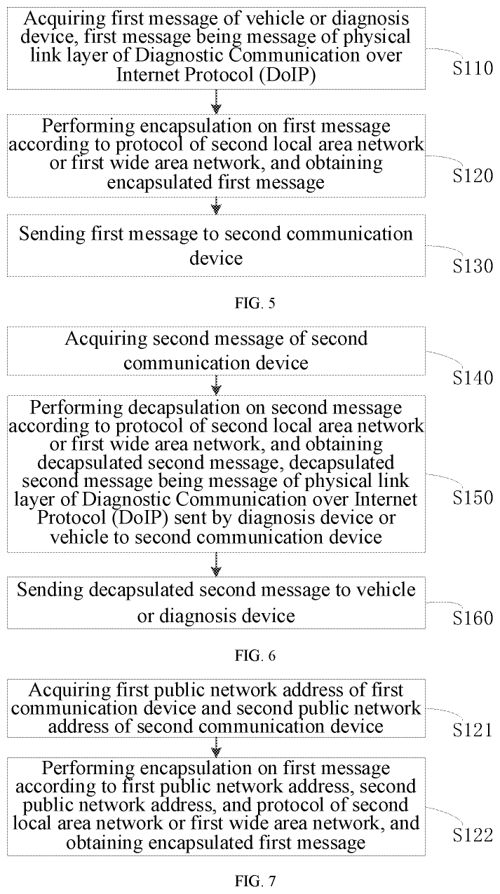

An embodiment of the present disclosure provides a communication method, being applied to a first communication device. The first communication device can be the first communication device 10 in FIG. 1 and FIG. 2, where the first communication device 10 is configured for being communicatively connected to a vehicle 50, or the second communication device 20 in FIG. 1 and FIG. 2, the second communication device 20 being used for being communicatively connected to a diagnosis device 40; referring to FIG. 4, the vehicle 50 and the diagnosis device 40 are disposed in a first local area network N1, and the first communication device 10 and the second communication device 20 are disposed in a second local area network or a first wide area network N2. Referring to FIG. 5, the method includes:
step S110: acquiring a first message of the vehicle 50 or the diagnosis device 40, the first message being a message of a physical link layer of a Diagnostic Communication over Internet Protocol (DoIP);
step S120: performing encapsulation on the first message according to a protocol of the second local area network or the first wide area network, and obtaining an encapsulated first message; and
step S130: sending the first message to the second communication device.

If the communication method is applied to the first communication device 10 in FIG. 4, the second communication device described in step S130 is the second communication device 20 in FIG. 4. In the present embodiment, the first communication device 10 can establish a communicative connection with the second communication device 20 through a server 30 as shown in FIG. 4, and can also directly establish a communicative connection with the second communication device 20 without the server 30, for example, a Peer-to-Peer (P2P) protocol is adopted for the communicative connection.

The first message can be a dynamic host configuration protocol (DHCP) request message, a broadcast message or a service message for communication between the diagnosis device 40 and an electronic control unit (ECU). The DHCP request message is a message in which the vehicle 50 requests the diagnosis device 40 to assign an address of the ECU.

In an embodiment, the first communication device 10 is communicatively connected to the vehicle 50 by adopting a DoIP bus, and the first communication device 10 can acquire the first message sent by the vehicle 50 through the bus. The first message is a message transmitted by the vehicle 50 to the first communication device 10 by adopting the DoIP.

In an embodiment of the present disclosure, referring to FIG. 4, the vehicle 50 and the diagnosis device 40 are disposed in the first local area network N1, the first communication device 10, the server 30 and the second communication device 20 are disposed in the first wide area network N2, or in an embodiment in which the server 30 is omitted, the first communication device 10 and the second communication device 20 are disposed in the second local area network.

Then, the first message is also a message of the physical link layer based on the protocol of the first local area network N1. After acquiring the first message, the first communication device 10 does not adopt the mode of firstly decapsulating the first message layer-by-layer according to a protocol of the third local area network M1 and then performing encapsulation on the first message layer-by-layer according to a protocol of the second wide area network M3, or firstly decapsulating the first message layer-by-layer according to the protocol of the third local area network M1 and then performing encapsulation on the first message layer-by-layer according to a protocol of the fifth local area network, as in the embodiment shown in FIG. 3. Instead, the first communication device 10 directly encapsulates the first message layer-by-layer based on a protocol of the first wide area network N2, or the first communication device 10 directly encapsulates the first message layer-by-layer based on the protocol of the second local area network. The encapsulated first message can enable the server 30 to forward the encapsulated first message to the second communication device 20, or directly send the encapsulated first message to the second communication device 20.

Subsequently, the first communication device 10 sends the encapsulated first message to the server 30 through a network, and after receiving the first message, the server 30 forwards the first message to the second communication device 20. If the first communication device 10 is communicatively connected to the second communication device 20 by adopting the P2P protocol, the first communication device 10 directly sends the encapsulated first message to the second communication device 20.

In the present embodiment, the first message sent by the vehicle 50 is not decapsulated layer-by-layer in the first communication device 10, but rather is directly sent to the server 30 after being encapsulated by the first communication device 10, and is directly forwarded to the second communication device 20 by the server 30. Compared with the mode in which after receiving the first message, the first communication device 10 firstly performs decapsulation on the first message layer-by-layer based on the protocol of the third local area network M1 and then performs encapsulation on the first message layer-by-layer based on the protocol of the second wide area network M3, or the mode in which the first communication device 10 performs decapsulation on the first message layer-by-layer according to the protocol of the third local area network M1 and then performs encapsulation on the first message layer-by-layer according to the protocol of the third local area network in the embodiment shown in FIG. 3, in the present embodiment, after receiving the first message, the first communication device 10 does not decapsulate the first message layer-by-layer, but rather directly performs encapsulation on the first message layer-by-layer based on the protocol of the first wide area network N2 or the second local area network. It can be seen that the present embodiment can reduce the amount of time the first communication device 10 processes the first message and improve communication speed.

If the communication method is applied to the second communication device 20 in FIG. 4, the second communication device 20 is configured for being communicatively connected to the diagnosis device 40, and the second communication device described in step S130 is the first communication device 10 in FIG. 4, in the present embodiment, the second communication device 20 can establish a communicative connection with the first communication device 10 through the server 30 as shown in FIG. 4, or can also directly establish a communicative connection with the first communication device 10 without the server 30, for example, the P2P protocol is adopted for the communicative connection.

The first message can be a response message of the diagnosis device 40 based on the DHCP request message, a broadcast message or a service message for communication between the diagnosis device 40 and the ECU.

In an embodiment, the second communication device 20 is communicatively connected to the diagnosis device 40 by adopting the DoIP bus, and the second communication device 20 can acquire the first message sent by the diagnosis device 40 through the bus. The first message is a message transmitted by the diagnosis device 40 to the second communication device 20 by adopting the DoIP.

In the embodiment of the present disclosure, referring to FIG. 4, the vehicle 50 and the diagnosis device 40 are disposed in the first local area network N1, the first communication device 10, the server 30 and the second communication device 20 are disposed in the first wide area network N2, or in an embodiment in which the server 30 is omitted, the first communication device 10 and the second communication device 20 are disposed in the second local area network.

Then, the first message is also a message of the physical link layer based on the protocol of the first local area network N1. After acquiring the first message, the second communication device 20 does not adopt the mode of firstly decapsulating the first message layer-by-layer according to a protocol of the fourth local area network M2 and then performing encapsulation on the first message layer-by-layer according to the protocol of the second wide area network M3, or performing decapsulation on the first message layer-by-layer according to the protocol of the fourth local area network M2 and then performing encapsulation on the first message layer-by-layer according to the protocol of the fifth local area network, as in the embodiment shown in FIG. 3. Instead, the second communication device 20 directly encapsulates the first message layer-by-layer based on the protocol of the first wide area network N2, or the second communication device 20 directly encapsulates the first message layer-by-layer based on the protocol of the second local area network. The encapsulated first message can enable the server 30 to forward the encapsulated first message to the first communication device 10, or directly send the encapsulated first message to the first communication device 10.

Subsequently, the second communication device 20 sends the encapsulated first message to the server 30 through a network, and after receiving the first message, the server 30 forwards the first message to the first communication device 10. If the first communication device 10 is communicatively connected to the second communication device 20 by adopting the P2P protocol, the second communication device 20 directly sends the encapsulated first message to the first communication device 10.

In the present embodiment, the first message sent by the diagnosis device 40 is not decapsulated layer-by-layer in the second communication device 20, but rather is directly sent to the server 30 after being encapsulated by the second communication device 20, and is directly forwarded to the first communication device 10 by the server 30. Compared with the mode in which after receiving the first message, the second communication device 20 firstly performs decapsulation on the first message layer-by-layer based on the protocol of the fourth local area network M2 and then performs encapsulation on the first message layer-by-layer based on to the protocol of the second wide area network M3, or the mode in which the second communication device 20 firstly performs decapsulation on the first message layer-by-layer according to the protocol of the fourth local area network M2 and then performs encapsulation on the first message layer-by-layer according to the protocol of the third local area network in the embodiment shown in FIG. 3, in the present embodiment, after receiving the first message, the second communication device 20 does not decapsulate the first message layer-by-layer, but rather directly performs encapsulation on the first message layer-by-layer based on the protocol of the first wide area network N2 or the second local area network. It can be seen that the present embodiment can reduce the amount of time the second communication device 20 processes the first message and improve communication speed.

In some embodiments, referring to FIG. 6, the method further includes:
step S140: acquiring a second message of the second communication device;
step S150: performing decapsulation on the second message according to the protocol of the second local area network or the first wide area network, and obtaining a decapsulated second message, the decapsulated second message being a message of the physical link layer of the Diagnostic Communication over Internet Protocol (DoIP) sent by the diagnosis device or the vehicle to the second communication device; and
step S160: sending the decapsulated second message to the vehicle or the diagnosis device.

If the communication method is applied to the first communication device 10 in FIG. 4, the first communication device 10 can receive the second message of the second communication device 20 through the server 30, and the second communication device described in the step S140 is the second communication device 20 in FIG. 4.

After receiving the second message, the first communication device 10 performs decapsulation on the second message layer-by-layer based on the protocol of the first wide area network N2 or the second local area network, and after the decapsulation is completed, a message of the physical link layer based on the DoIP sent by the diagnosis device 40 to the second communication device 20 is acquired. The decapsulated second message can be a response message of the diagnosis device 40 based on the DHCP request message, a broadcast message or a service message for communication between the diagnosis device 40 and the ECU.

Subsequently, the first communication device 10 directly sends the decapsulated second message to the vehicle 50 through the bus, and after receiving the decapsulated second message, the vehicle 50 performs decapsulation on the decapsulated second message layer-by-layer based on the protocol of the first local area network N1, so as to acquire service data sent by the diagnosis device 40, such as a message for assigning address information of the ECU or other application messages.

Compared with the mode in which after receiving the second message, the first communication device 10 firstly decapsulates the second message layer-by-layer based on the protocol of the second wide area network M3 and then encapsulates the second message layer-by-layer based on the protocol of the third local area network M1 in the embodiment shown in FIG. 3, or compared with the mode in which the first communication device 10 firstly decapsulates the second message layer-by-layer based on the protocol of the fifth local area network and then encapsulates the second message layer-by-layer based on the protocol of the third local area network M1, in the present embodiment, after receiving the second message, the first communication device 10 only decapsulates the second message layer-by-layer based on the protocol of the first wide area network N2 or the second local area network, and does not need to encapsulate the second message subsequently, but rather directly sends the decapsulated second message to the vehicle 50 through the bus. It can be seen that the present embodiment can reduce the amount of time the first communication device 10 processes the second message and improve communication speed.

If the communication method is applied to the second communication device 20 in FIG. 4, the second communication device 20 can acquire the second message sent by the server 30 through the network, and the second communication device described in the step S140 is the first communication device 10 in FIG. 4.

After receiving the second message, the second communication device 20 performs decapsulation on the second message layer-by-layer based on the protocol of the first wide area network N2 or the second local area network, and after the decapsulation is completed, a message of the physical link layer based on the DoIP sent by the vehicle 50 to the first communication device 10 is acquired. The decapsulated second message can be a DHCP request message, a broadcast message or a service message for communication between the diagnosis device 40 and the ECU.

Subsequently, the second communication device 20 directly sends the decapsulated second message to the diagnosis device 40 through the bus, and after receiving the decapsulated second message, the diagnosis device 40 performs decapsulation on the decapsulated second message layer-by-layer based on the protocol of the first local area network N1, so as to acquire service data sent by the vehicle 50.

Compared with the mode in which after receiving the second message, the second communication device 20 firstly decapsulates the second message layer-by-layer based on the protocol of the second wide area network M3 and then encapsulates the second message layer-by-layer based on the protocol of the fourth local area network M2 in the embodiment shown in FIG. 3, or compared with the mode in which the second communication device 20 firstly decapsulates the second message layer-by-layer based on the protocol of the third local area network and then encapsulates the second message layer-by-layer based on the protocol of the fourth local area network M2, in the present embodiment, after receiving the second message, the first communication device 10 only decapsulates the second message layer-by-layer based on the protocol of the first wide area network N2 or the second local area network, and does not need to encapsulate the second message subsequently, but rather directly sends the decapsulated second message to the diagnosis device 40 through the bus. It can be seen that the present embodiment can reduce the amount of time the second communication device 20 processes the second message and improve communication speed.

In some embodiments, referring to FIG. 7, the step S120 includes:
step S121: acquiring a first public network address of the first communication device 10 and a second public network address of the second communication device 20;
the first public network address of the first communication device 10 being an address of the first communication device 10 which is directly accessible on the Internet, and the second public network address of the second communication device 20 being an address of the second communication device 20 which is directly accessible on the Internet; and
step S122: performing encapsulation on the first message according to the first public network address, the second public network address, and the protocol of the second local area network or the wide area network, and obtaining the encapsulated first message.

When performing encapsulation on the first message, the encapsulation is performed on the first message layer-by-layer directly by utilizing the first public network address and the second public network address based on the protocol of the first wide area network N2 or the second local area network, and the encapsulated first message is obtained. At this time, the encapsulated first message is a message of the physical link layer based on the protocol of the first wide area network N2 or the second local area network, and reference may be made to the prior art for a specific encapsulation process of the first message, which is not limited herein. It should be noted that when performing encapsulation layer-by-layer based on the protocol of the second local area network, both the first public network address and the second public network address are addresses of local area networks. In this way, after the server 30 receives the encapsulated first message, the first communication device 10 forwards the first message to the second communication device 20 according to the second public network address, or the second communication device 20 forwards the first message to the first communication device 10 according to the first public network address.

In the present embodiment, by performing encapsulation on the first message by utilizing the first public network address and the second public network address, the encapsulated first message can be forwarded to the second communication device 20 or the first communication device 10 by the server 30 or without the server 30.

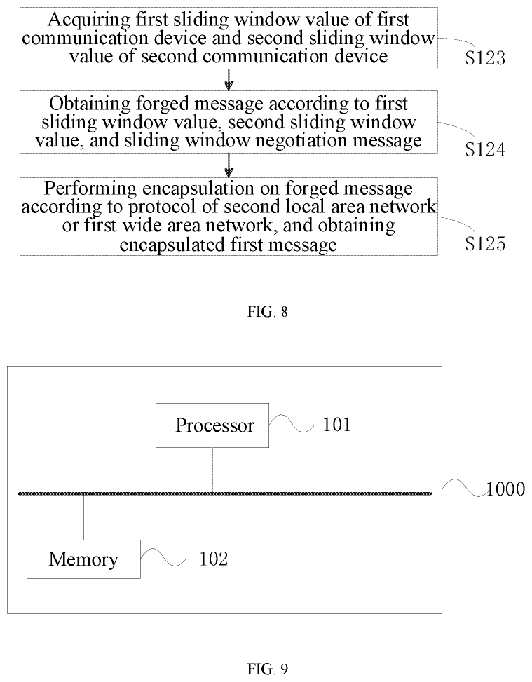

In some embodiments, the first message is a sliding window negotiation message. Referring to FIG. 8, the performing encapsulation on the first message according to a protocol of the second local area network or the first wide area network, and obtaining an encapsulated first message, includes:
step S123: acquiring a first sliding window value of the first communication device 10 and a second sliding window value of the second communication device 20.

In the embodiment shown in FIG. 4, after the first communication device 10 establishes a communicative connection with the second communication device 20, the first communication device 10 acquire the first sliding window value and the second sliding window value, where the first sliding window value is a maximum value of message data that the first communication device 10 can actually receive, and the second sliding window value is a maximum value of message data that the second communication device 20 can actually receive.
Step S124: obtaining a forged message according to the first sliding window value, the second sliding window value, and the sliding window negotiation message.

In an embodiment, after acquiring the sliding window negotiation message, the first communication device 10 obtains a maximum value of message data that the vehicle 50 can actually receive. Subsequently, the first communication device 10 determines a minimum sliding window value according to the first sliding window value, the second sliding window value and the maximum value of the message data that the vehicle 50 can actually receive. If the minimum sliding window value is the maximum value of the message data that the vehicle 50 can actually receive, there is no need to forge the sliding window negotiation message, that is, the forged message is the sliding window negotiation message. If the minimum sliding window value is the first sliding window value or the second sliding window value, the first communication device 10 forges the message according to the minimum sliding window value and the sliding window negotiation message, modifies sliding window values and a checksum in the sliding window negotiation message, and the forged message is obtained. The forged message is also a message of the physical link layer based on the protocol of the first local area network N1 and based on the DoIP.
Step S125: performing encapsulation on the forged message according to the protocol of the second local area network or the wide area network, and obtaining the encapsulated first message.

Subsequently, the first communication device 10 performs encapsulation on the forged message layer-by-layer according to the protocol of the first wide area network N2 or the second local area network, and the encapsulated first message is obtained. Then, after the encapsulated first message is sent to the diagnosis device 40 by the second communication device 20, the diagnosis device 40 returns a negotiation response message according to a sliding window value in the forged message and a sliding window value thereof, and the negotiation response message is forwarded to the vehicle 50 by the second communication device 20 and the first communication device 10.

In the present embodiment, the first communication device 10 determines the minimum sliding window value by utilizing the first sliding window value, the second sliding window value and the sliding window negotiation message, and adaptively modifies a sliding window value in the sliding window negotiation message by utilizing the minimum sliding window value, so that the data flow can be controlled reasonably and the condition of packet loss in the subsequent communication process can be reduced.

In some embodiments, the first message is one of a message in which the vehicle requests the diagnosis device to assign an address of the ECU, a broadcast message, a service message for communication between the diagnosis device and the ECU, and a response message of the diagnosis device based on the message in which the vehicle requests the diagnosis device to assign the address of the ECU. In the present embodiment, the first message can be one of the above messages, and the processing speed of the above messages can be improved by performing encapsulation on and sending the above messages.

An embodiment of the present disclosure further provides a first communication device. Referring to FIG. 9, FIG. 9 shows a hardware structure of the first communication device which can execute the communication methods according to FIG. 5 to FIG. 8. The first communication device can be the first communication device 10 or the second communication device 20 shown in FIG. 4.

The first communication device 1000 includes: at least one processor 101; and a memory 102 communicatively connected to the at least one processor 101. Including one processor 101 is taken as an instance in FIG. 9. The memory 102 stores instructions executable by the at least one processor 101, and the instructions are executed by the at least one processor 101 to cause the at least one processor 101 to execute the method according to any one of the method embodiments, that is, execute the communication methods according to FIG. 5 to FIG. 8 above. The processor 101 and the memory 102 can be connected through a bus or in other modes, and connection through the bus is taken as an instance in FIG. 9.

The memory 102, as a non-transitory computer-readable storage medium, can be used for storing non-volatile software programs, non-volatile computer-executable programs and modules, such as program instructions/modules corresponding to the communication method in the embodiments of the present disclosure. The processor 101 executes various functional applications and data processing of the server 30 by running the non-volatile software programs, instructions and modules stored in the memory 102, that is, implements the communication method according to any one of the method embodiments.

The memory 102 can include a program storage area and a data storage area, where the program storage area can store an operating system and an application program required for at least one function; and the data storage area can store data created according to the use of an apparatus and the like. In addition, the memory 102 can include a high-speed random access memory 102, and can also include a non-volatile memory 102, such as at least one magnetic disk memory 102 device, a flash memory device, or other non-volatile solid-state memory 102 devices. In some embodiments, the memory 102 optionally includes memories 102 remotely disposed relative to the processor 101, and these remote memories 102 can be connected to the first communication device through a network. Instances of the above network include, but are not limited to, the Internet, an enterprise intranet, a local area network, a mobile communication network, and combinations thereof.

The one or more modules are stored in the memory 102, and when executed by the one or more processors 101, execute the communication method according to any one of the method embodiments, for example, execute the steps of the communication methods according to FIG. 5 to FIG. 8 described above.

The above product can execute the method provided by the embodiments of the present disclosure, and has corresponding functional modules and beneficial effects for executing the method. For technical details not described in detail in the present embodiment, reference may be made to the method provided by any one of the embodiments mentioned above.

An embodiment of the present disclosure provides a remote diagnostic system, including the first communication device mentioned above, a second communication device, a diagnosis device 40 and a vehicle 50. The first communication device can be the first communication device 10 in FIG. 4, the first communication device 10 is communicatively connected to the vehicle 50 and the second communication device 20, and the second communication device 20 is further communicatively connected to the diagnosis device 40. Or, the first communication device can be the second communication device 20 in FIG. 4, that is, the first communication device is communicatively connected to the diagnosis device and the second communication device, and the second communication device is communicatively connected to the vehicle. In the present embodiment, the first communication device has the same structure and function as the first communication device, which will not be repeated herein.

In some embodiments, the vehicle 50 and the diagnosis device 40 are disposed in the first local area network N1, and the first communication device 10 and the second communication device 20 are disposed in the second local area network or the first wide area network. In the remote diagnostic system, through the above disposition, the first communication device 10 and the second communication device 20 can perform encapsulation and decapsulation on the message according to the corresponding protocol, which reduces the time consumed for message processing and improves communication speed.

In some embodiments, the remote diagnostic system further includes a server 30; and the first communication device 10 is communicatively connected to the second communication device 20 through the server 30. In the present embodiment, data forwarding is performed between the first communication device 10 and the second communication device 20 by adopting the server 30, which can improve the communication quality.

In an embodiment, the first communication device 10 is connected to the vehicle 50 by adopting a DoIP bus, and the second communication device 20 is connected to the diagnosis device 40 by adopting the DoIP bus. In the remote diagnostic system, after the connection is established, the vehicle 50 sends a DHCP request message to the first communication device 10 through the bus, and then the first communication device 10 performs encapsulation on the DHCP request message layer-by-layer by utilizing the first public network address and the second public network address based on the protocol of the first wide area network N2, obtains an encapsulated message, and directly sends the encapsulated message to the server 30. The encapsulated message is forwarded to the second communication device 20 by the server 30, and the second communication device 20 performs decapsulation on the encapsulated message based on the protocol of the first wide area network N2, and obtains a decapsulated message, that is, obtains the DHCP request message sent by the vehicle 50 to the first communication device 10. Moreover, the second communication device 20 sends the DHCP request message to the diagnosis device 40 through the bus, and after receiving the DHCP request message, the diagnosis device 40 decapsulates the DHCP request message layer-by-layer based on the protocol of the first local area network N1, and acquires an application message in which the vehicle 50 requests to assign Internet Protocol (IP) address information.

Subsequently, the diagnosis device 40 acquires an application message of the IP address information of the vehicle 50 according to the application message in which the vehicle 50 requests to assign IP address information, encapsulates the application message layer-by-layer based on the protocol of the first local area network N1, acquires a message of a physical link layer, and then sends the message including the physical link layer to the second communication device 20 through the bus. Then, the second communication device 20 performs encapsulation on the message of the physical link layer layer-by-layer by utilizing the first public network address and the second public network address based on the protocol of the first wide area network N2, and obtains an encapsulated message. The encapsulated message is forwarded to the first communication device 10 by the server 30, the first communication device 10 performs decapsulation on the encapsulated message based on the protocol of the first wide area network N2, and obtains a decapsulated message, that is, a message of the physical link layer sent by the diagnosis device 40 to the second communication device 20, and the first communication device 10 sends the message of the physical link layer to the vehicle 50 through the bus. After receiving the message of the physical link layer, the vehicle 50 decapsulates the message layer-by-layer based on the protocol of the first local area network N1, and obtains the application message of the IP address information of the vehicle 50.

When transmitting service data in the remote diagnostic system subsequently, the service message is also transmitted in the above mode, and a specific process is as follows: the vehicle 50 sends the message of the physical link layer based on the protocol of the first local area network N1 to the first communication device 10 through the bus. Then, the first communication device 10 performs encapsulation on the message of the physical link layer based on the protocol of the first wide area network N2, obtains the encapsulated message, and directly sends the encapsulated message to the server 30. The encapsulated message is forwarded to the second communication device 20 by the server 30, the second communication device 20 performs decapsulation on the message of the physical link layer based on the protocol of the first wide area network N2, and obtains the decapsulated message, that is, the message of the physical link layer based on the protocol of the first local area network N1 sent by the vehicle 50 to the first communication device 10 through the bus, and the second communication device 20 sends the message of the physical link layer to the diagnosis device 40 through the bus. After receiving the message of the physical link layer, the diagnosis device 40 performs decapsulation on the message layer-by-layer based on the protocol of the first local area network N1, and obtains the application message.

Similarly, the diagnosis device 40 sends the message of the physical link layer based on the protocol of the first local area network N1 to the second communication device 20 through the bus. Then, the second communication device 20 performs encapsulation on the message of the physical link layer based on the protocol of the first wide area network N2, obtains the encapsulated message, and directly sends the encapsulated message to the server 30. The encapsulated message is forwarded to the first communication device 10 by the server 30, and the first communication device 10 performs decapsulation on the message of the physical link layer based on the protocol of the first wide area network N2, and obtains the decapsulated message, that is, the message of the physical link layer based on the protocol of the first local area network N1 sent by the diagnosis device 40 to the second communication device 20 through the bus. Moreover, the first communication device 10 sends the message of the physical link layer to the vehicle 50 through the bus, and after receiving the message of the physical link layer, the vehicle 50 decapsulates the message layer-by-layer based on the protocol of the first local area network N1, and obtain the application message.

It can be seen that in the remote diagnostic system provided by the present embodiment, the first communication device 10 or the second communication device 20 directly encapsulates the message sent by the vehicle 50 or the diagnosis device 40 based on the protocol of the first wide area network N2 and then sends the message to the server 30. Moreover, after the first communication device 10 or the second communication device 20 decapsulates the message sent by the server 30 based on the protocol of the first wide area network N2, there is no need to perform encapsulation on the message layer-by-layer based on to the protocol of the third local area network M1 or the fourth local area network M2 as in the embodiment shown in FIG. 3, but rather the decapsulated message is directly sent to the vehicle 50 or the diagnosis device 40, which reduces the time consumed for message processing by the first communication device 10 or the second communication device 20 and improves communication speed in the remote diagnostic system.

An embodiment of the present disclosure further provides a non-transitory computer-readable storage medium, storing computer-executable instructions, where the computer-executable instructions are executed by one or more processors, for example, to execute the steps of the method according to any one of the method embodiments.

An embodiment of the present disclosure further provides a computer program product, including a computer program stored on a non-volatile computer-readable storage medium, where the computer program includes program instructions, and the program instructions, when executed by a computer, cause the computer to execute the steps of the method according to any one of the method embodiments.

It should be noted that the apparatus embodiments described above are merely illustrative, wherein units described as separate components may be or may not be physically separate, and the components shown as units may be or may not be physical units, that is, they may be positioned in one place, or may be distributed on a plurality of network units. Some or all of the modules can be selected according to actual needs to achieve the objective of the solution of the present embodiment.

From the above description of the implementation modes, those skilled in the art can clearly understand that each implementation mode can be implemented by means of software plus a general hardware platform, and of course, can also be implemented by means of hardware. Based on such understanding, the above technical solution in essence or the part which makes a contribution to the related art can be embodied in the form of a software product. The computer software product can be stored in the computer-readable storage medium, such as a read-only memory/random-access memory (ROM/RAM), a magnetic disk and an optical disc, and includes several instructions for causing at least one computer device (which can be a personal computer, a server, or a network device, and the like) to execute the method according to each embodiment or some parts of the embodiment.

The above embodiments are only used for illustrating the technical solutions of the present disclosure, but are not intended to limit them; under the concept of the present disclosure, the technical features in the above embodiments or different embodiments can be combined with each other, the steps can be implemented in any order, and there are many other variations of the present disclosure in different aspects as described above, which are not provided in details for the sake of brevity; although the present disclosure has been described in detail with reference to the foregoing embodiments, those ordinarily skilled in the art should understand that they can still modify the technical solutions described in the foregoing embodiments, or equivalently replace some of the technical features; and such modifications or replacements do not make the essence of the corresponding technical solution depart from the scope of the technical solution of each embodiment of the present disclosure.

What is claimed is:

1. A communication method, comprising:
acquiring, by a first communication device, a first message of a vehicle or a diagnosis device, wherein the first message is a message of a physical link layer of a Diagnostic Communication over Internet Protocol (DoIP), wherein the first communication device is configured for being communicatively connected to the vehicle or the diagnosis device, the vehicle and the diagnosis device are disposed in a first local area network, and the first communication device and a second communication device are disposed in a second local area network or a first wide area network;
performing, by the first communication device, encapsulation on the first message according to a protocol of the second local area network or the first wide area network, and obtaining, by the first communication device, an encapsulated first message; and
sending, by the first communication device, the encapsulated first message to the second communication device.

2. The method according to claim 1, further comprising:
acquiring, by the first communication device, a second message of the second communication device;
performing, by the first communication device, decapsulation on the second message according to the protocol of the second local area network or the first wide area network, and obtaining a decapsulated second message, the decapsulated second message being a message of the physical link layer of the Diagnostic Communication over Internet Protocol (DoIP) sent by the diagnosis device or the vehicle to the second communication device; and
sending, by the first communication device, the decapsulated second message to the vehicle or the diagnosis device.

3. The method according to claim 1, wherein performing the encapsulation on the first message according to the protocol of the second local area network or the first wide area network, and obtaining the encapsulated first message comprises:
acquiring a first public network address of the first communication device and a second public network address of the second communication device; and
performing encapsulation on the first message according to the first public network address, the second public network address, and the protocol of the second local area network or the first wide area network, and obtaining the encapsulated first message.

4. The method according to claim 3, wherein the first message is a sliding window negotiation message, and performing the encapsulation on the first message according to the protocol of the second local area network or the first wide area network, and obtaining the encapsulated first message comprises:
acquiring a first sliding window value of the first communication device and a second sliding window value of the second communication device;
obtaining a forged message according to the first sliding window value, the second sliding window value, and the sliding window negotiation message; and
performing encapsulation on the forged message according to the protocol of the second local area network or the first wide area network, and obtaining the encapsulated first message.

5. The method according to claim 1, wherein
the first message is one of a message in which the vehicle requests the diagnosis device to assign an address of an electronic control unit, a broadcast message, a service message for communication between the diagnosis device and the electronic control unit, and a response message of the diagnosis device based on the message in which the vehicle requests the diagnosis device to assign the address of the electronic control unit.

6. A first communication device, comprising:
one or more processors; and
a memory communicatively connected to the one or more processors; wherein
the memory stores instructions executable by the one or more processors, and the instructions are executed by the one or more processors to cause the one or more processors to perform acts comprising:
acquiring a first message of a vehicle or a diagnosis device, the first message being a message of a physical link layer of a Diagnostic Communication over Internet Protocol (DoIP); wherein the first communication device is configured for being communicatively connected to the vehicle or the diagnosis device, the vehicle and the diagnosis device being disposed in a first local area network, the first communication device and a second communication device being disposed in a second local area network or a first wide area network;
performing encapsulation on the first message according to a protocol of the second local area network or the first wide area network, and obtaining an encapsulated first message; and
sending the encapsulated first message to the second communication device.

7. A remote diagnostic system, comprising the first communication device according to claim 6, a second communication device, a diagnosis device, and a vehicle; wherein
the first communication device is communicatively connected to the vehicle and the second communication device, and the second communication device is further communicatively connected to the diagnosis device; or
the first communication device is communicatively connected to the diagnosis device and the second communication device, and the second communication device is further communicatively connected to the vehicle.

8. The remote diagnostic system according to claim 7, wherein the vehicle and the diagnosis device are disposed in a first local area network, and the first communication device and the second communication device are disposed in a second local area network or a first wide area network.

9. The remote diagnostic system according to claim 7, further comprising a server;
wherein the first communication device is communicatively connected to the second communication device through the server.

10. A non-transitory computer-readable storage medium, storing computer-executable instructions, wherein the computer-executable instructions are used for causing a computer to perform acts comprising:
acquiring a first message of a vehicle or a diagnosis device, the first message being a message of a physical link layer of a Diagnostic Communication over Internet Protocol (DoIP); wherein the first communication device is configured for being communicatively connected to the vehicle or the diagnosis device, the vehicle and the diagnosis device are disposed in a first local area network, the first communication device and a second communication device are disposed in a second local area network or a first wide area network;
performing encapsulation on the first message according to a protocol of the second local area network or the first wide area network, and obtaining an encapsulated first message; and
sending the encapsulated first message to the second communication device.

11. The first communication device according to claim 6, wherein the one or more processors are caused to perform acts further comprising:
acquiring a second message of the second communication device;
performing the decapsulation on the second message according to the protocol of the second local area network or the first wide area network, and obtaining a decapsulated second message, the decapsulated second message being a message of the physical link layer of the Diagnostic Communication over Internet Protocol (DoIP) sent by the diagnosis device or the vehicle to the second communication device; and
sending the decapsulated second message to the vehicle or the diagnosis device.

12. The first communication device according to claim 11, wherein performing the encapsulation on the first message according to the protocol of the second local area network or the first wide area network, and obtaining the encapsulated first message comprises:
acquiring a first public network address of the first communication device and a second public network address of the second communication device; and
performing encapsulation on the first message according to the first public network address, the second public network address, and the protocol of the second local area network or the first wide area network, and obtaining the encapsulated first message.

13. The first communication device according to claim 12, wherein the first message is a sliding window negotiation message, and performing the encapsulation on the first message according to the protocol of the second local area network or the first wide area network, and obtaining the encapsulated first message comprises:
acquiring a first sliding window value of the first communication device and a second sliding window value of the second communication device;
obtaining a forged message according to the first sliding window value, the second sliding window value, and the sliding window negotiation message; and
performing encapsulation on the forged message according to the protocol of the second local area network or the first wide area network, and obtaining the encapsulated first message.

14. The first communication device according to claim 6, wherein
the first message is one of a message in which the vehicle requests the diagnosis device to assign an address of an electronic control unit, a broadcast message, a service message for communication between the diagnosis device and the electronic control unit, and a response message of the diagnosis device based on the message in which the vehicle requests the diagnosis device to assign the address of the electronic control unit.

15. The non-transitory computer-readable storage medium according to claim 10, wherein the computer is caused to perform acts further comprising:
acquiring a second message of the second communication device;
performing the decapsulation on the second message according to the protocol of the second local area network or the first wide area network, and obtaining a decapsulated second message, the decapsulated second message being a message of the physical link layer of the Diagnostic Communication over Internet Protocol (DoIP) sent by the diagnosis device or the vehicle to the second communication device; and
sending the decapsulated second message to the vehicle or the diagnosis device.

16. The non-transitory computer-readable storage medium according to claim 15, wherein performing the encapsulation on the first message according to the protocol of the second local area network or the first wide area network, and obtaining the encapsulated first message comprises:
acquiring a first public network address of the first communication device and a second public network address of the second communication device; and
performing encapsulation on the first message according to the first public network address, the second public network address, and the protocol of the second local area network or the first wide area network, and obtaining the encapsulated first message.

17. The non-transitory computer-readable storage medium according to claim 16, wherein the first message is a sliding window negotiation message, and performing the encapsulation on the first message according to the protocol of the second local area network or the first wide area network, and obtaining the encapsulated first message comprises:
acquiring a first sliding window value of the first communication device and a second sliding window value of the second communication device;
obtaining a forged message according to the first sliding window value, the second sliding window value, and the sliding window negotiation message; and
performing encapsulation on the forged message according to the protocol of the second local area network or the first wide area network, and obtaining the encapsulated first message.

18. The non-transitory computer-readable storage medium according to claim 10, wherein
the first message is one of a message in which the vehicle requests the diagnosis device to assign an address of an electronic control unit, a broadcast message, a service message for communication between the diagnosis device and the electronic control unit, and a response message of the diagnosis device based on the message in which the vehicle requests the diagnosis device to assign the address of the electronic control unit.
